(19) United States
(12) Patent Application Publication
(10) Pub. No.: US 2026/0153051 A1
(43) Pub. Date: Jun. 4, 2026

(54) ELECTRIC TURBOCHARGER WITH HEAT SUPPRESSION

(71) Applicant: IHI Corporation, Tokyo (JP)

(72) Inventors: Tatsumi INOMATA, Tokyo (JP); Ryosuke YUMOTO, Tokyo (JP); Kai IIJIMA, Tokyo (JP)

(21) Appl. No.: 19/457,177

(22) Filed: Jan. 23, 2026

Related U.S. Application Data
(63) Continuation of application No. PCT/JP2024/009403, filed on Mar. 11, 2024.

(30) Foreign Application Priority Data
Jul. 26, 2023 (JP) 2023-121410

(51) Int. Cl. F02C 6/12

(52) U.S. Cl. CPC F02C 6/12; F05D 2220/40; F05D 2220/768; F05D 2260/231

(57) ABSTRACT

An example electric turbocharger includes a compressor, a motor configured to apply torque to an impeller of the compressor, a motor case that houses the motor and contacts the compressor along a rotation axis of the impeller, and a gap region formed between the compressor and the motor case in an axial direction of the rotation axis to suppress heat transfer from the compressor to the motor.

### CROSS-REFERENCE TO RELATED APPLICATIONS

This application is a continuation application of PCT Application No. PCT/JP 2024/009403, filed on Mar. 11, 2024, which claims the benefit of priority from Japanese Patent Application No. 2023-121410, filed on Jul. 26, 2023. The entire contents of the above listed PCT and priority applications are incorporated herein by reference.

### BACKGROUND

### Field

The present disclosure relates to an electric turbocharger.

### Description of the Related Art

Japanese Unexamined Patent Application Publication No. 2009-024576 discloses an electric turbocharger having a structure in which a compressor and a motor unit that applies a torque to an impeller of the compressor are connected in a rotation axis direction. In this type of electric turbocharger, heat is generated in the compressor due to adiabatic compression of a gas, and a part of the heat is conducted from the compressor to the motor side.

### SUMMARY

If a large amount of heat is conducted from the compressor to the motor side, it may cause an increase in the temperature of the motor, and operating performance of the motor may be reduced by the heat. Also, since the heat from the compressor is eventually processed by the cooling system that cools the motor, the heat increases a load on the cooling system.

Disclosed herein is an example electric turbocharger that may include a compressor, and a motor unit including a motor case joined to the compressor in a rotation axis direction and applying a torque to an impeller of the compressor, in which at a joint portion between the compressor and the motor case, a gap region, in which the compressor and the motor case face each other in the rotation axis direction with a gap therebetween, is provided.

### BRIEF DESCRIPTION OF THE DRAWINGS

FIG. 1 is a cross-sectional view illustrating an example electric turbocharger.

FIG. 2 is an enlarged cross-sectional view illustrating a part of the electric turbocharger of FIG. 1.

FIG. 3 is a view of a joint surface of a motor case, which is joined to a compressor, from an axial direction.

FIG. 4 is a view of a modified example of the joint surface of the motor case, which is joined to the compressor, from the axial direction.

### DETAILED DESCRIPTION

Disclosed herein is an example electric turbocharger including a compressor, and a motor unit including a motor case joined to the compressor in a rotation axis direction and applying a torque to an impeller of the compressor, in which at a joint portion between the compressor and the motor case, a gap region, in which the compressor and the motor case face each other in the rotation axis direction with a gap therebetween, is provided.

In the electric turbocharger, a radial position of an outermost circumferential portion of the gap region may be the same as or positioned outward of a radial position of a diffuser outlet of the compressor, and may be the same as or positioned inward of a radial position of an outermost circumferential portion of a scroll of the compressor.

In the electric turbocharger, a radial position of a diffuser outlet of the compressor may be positioned inward of a radial position of an outermost circumferential portion of the gap region and positioned outward of a radial position of an innermost circumferential portion of the gap region.

In the electric turbocharger, the gap region may be divided into a plurality of regions in a circumferential direction.

In the electric turbocharger, a projected area of the gap region projected in the rotation axis direction may be 40% or more of a total projected area of the joint portion projected in the rotation axis direction.

In the electric turbocharger, a cooling air flow path providing communication between the outside of the motor case and a space in which a bearing of the motor unit is housed, and through which a cooling air for cooling the bearing flows, may be formed in the motor case, and the gap region may be provided at a position that does not overlap a cooling air flow path when viewed from the rotation axis direction.

In the electric turbocharger, the compressor may include a compressor housing, and a diffuser plate forming a diffuser between itself and the compressor housing and joined to the motor case at the joint portion, and the diffuser plate may be made of stainless steel.

In the following description, with reference to the drawings, the same reference numbers are assigned to the same components or to similar components having the same function, and overlapping description is omitted.

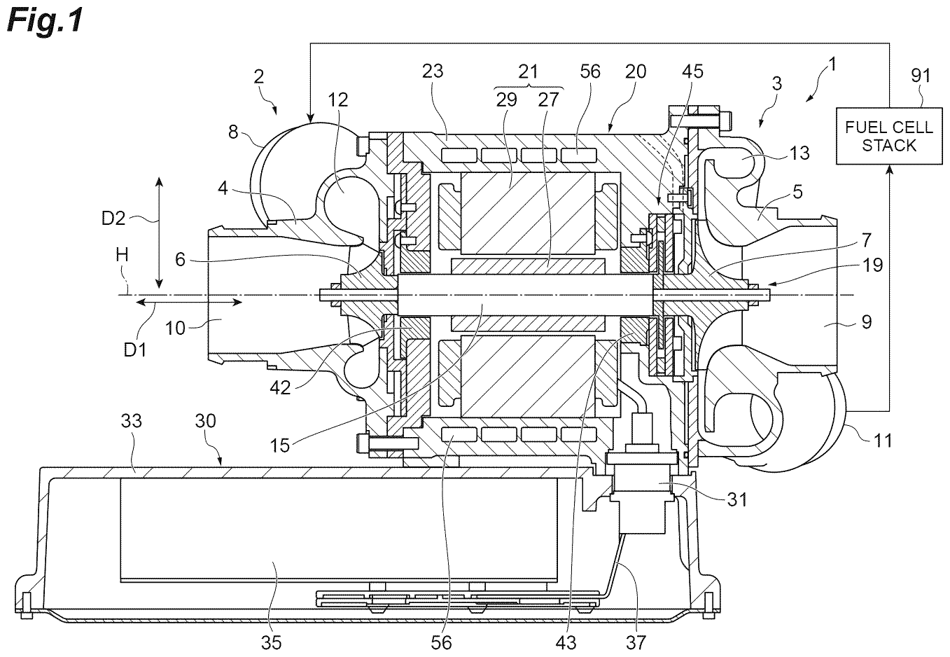

In the following description, when the terms “axial direction,” “radial direction,” and “circumferential direction” are simply used, they respectively refer to a rotation axis direction (direction of a rotation axis H), a rotation radial direction, and a rotation circumferential direction of a rotating shaft 15 of the electric turbocharger 1. Also, in the direction of the rotation axis H, a turbine 2 side (left side in FIG. 1) of the electric turbocharger 1 may be simply referred to as a “turbine side” and a compressor 3 side (right side in FIG. 1) may be simply referred to as a “compressor side”.

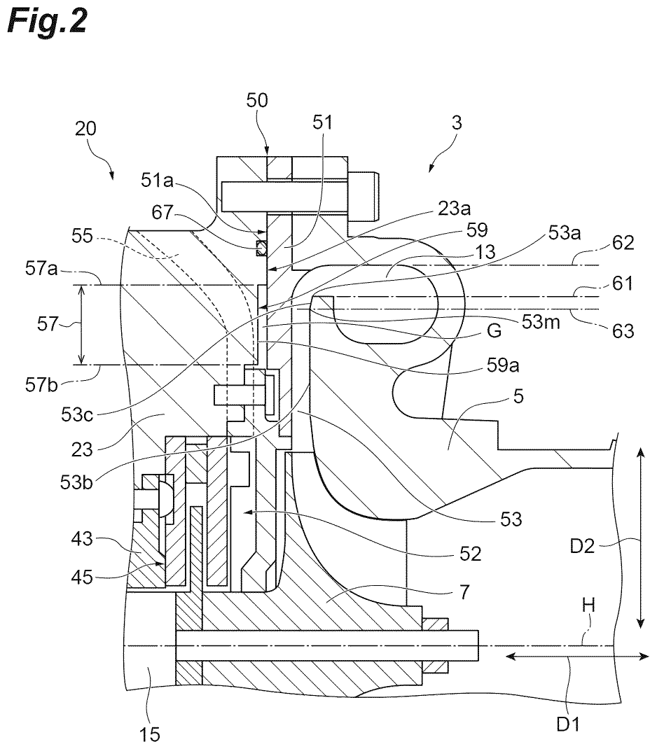

FIG. 1 is a cross-sectional view illustrating the electric turbocharger 1, and FIG. 2 is an enlarged cross-sectional view illustrating a part thereof. The electric turbocharger 1 illustrated in FIG. 1 and FIG. 2 is an electric-assist type turbocharger mounted on a fuel cell vehicle. The electric turbocharger 1 supplies a generated compressed air to a fuel cell stack 91 to increase an amount of oxygen involved in a chemical reaction in the fuel cell stack 91.

The electric turbocharger 1 includes the turbine 2 and the compressor 3. The electric turbocharger 1 further includes a motor unit 20 installed between the turbine 2 and the compressor 3, and an inverter unit 30 that supplies power to the motor unit 20.

The turbine 2 includes a turbine housing 4 and a turbine impeller 6 housed in the turbine housing 4. The turbine housing 4 includes a scroll 12 extending in the circumferential direction D3 around the turbine impeller 6. Also, the turbine housing 4 includes an exhaust gas inlet 8 and an exhaust gas outlet 10. The compressor 3 includes a compressor housing 5 and a compressor impeller 7 housed in the compressor housing 5. The compressor housing 5 includes a scroll 13 extending in the circumferential direction D3 around the compressor impeller 7. Also, an intake port 9 and a discharge port 11 are provided in the compressor housing 5. The compressor 3 has a structure of a centrifugal compressor, and the compressor impeller 7 discharges air introduced in the axial direction D1 from the intake port 9 outward in the radial direction D2 toward the scroll 13.

Also, the electric turbocharger 1 has the rotating shaft 15 connecting the turbine impeller 6 and the compressor impeller 7. That is, the turbine impeller 6 is provided at one end of the rotating shaft 15, and the compressor impeller 7 is provided at the other end of the rotating shaft 15. The turbine impeller 6, the rotating shaft 15, and the compressor impeller 7 constitute a rotating body 19 that integrally rotates around the rotation axis H.

The motor unit 20 includes a motor 21 and a motor case 23 that houses the motor 21. The motor 21 is, for example, a brushless AC motor and includes a rotor 27 as a rotating element and a stator 29 as a stationary element. The rotor 27 is fixed to the rotating shaft 15 and is positioned between the turbine impeller 6 and the compressor impeller 7. The stator 29 is disposed to surround a circumference of the rotor 27 and is fixed to the motor case 23.

Also, the rotating shaft 15 penetrates the motor case 23 in the axial direction D1. At penetration portions of the rotating shaft 15, a pair of radial bearings 42 and 43 supporting the rotating shaft 15 are provided in the motor case 23. The radial bearing 42 on the turbine side is positioned between the motor 21 and the turbine impeller 6. The radial bearing 43 on the compressor side is positioned between the motor 21 and the compressor impeller 7. A thrust bearing 45 of the rotating shaft 15 is provided in the motor case 23. The thrust bearing 45 is positioned between the radial bearing 43 and the compressor impeller 7. The radial bearings 42 and 43 and the thrust bearing 45 are air bearings.

The inverter unit 30 is connected to the motor unit 20 via a connector 31. The inverter unit 30 includes an inverter case 33 positioned outside the motor case 23, an inverter main body 35 and a busbar 37 housed in the inverter case 33. The inverter main body 35 is electrically connected to the stator 29 of the motor 21 via the busbar 37 and the connector 31.

In this electric turbocharger 1, an exhaust gas discharged from the fuel cell stack 91 flows into the turbine housing 4 through the exhaust gas inlet 8. The exhaust gas then flows into the turbine impeller 6 through the scroll 12, causing the turbine impeller 6 to rotate around the rotation axis H. Thereafter, the exhaust gas flows out of the turbine housing 4 through the exhaust gas outlet 10. When the turbine impeller 6 rotates as described above, the compressor impeller 7 rotates via the rotating shaft 15. The rotating compressor impeller 7 draws in outside air through the intake port 9. This air passes through the compressor impeller 7 and the scroll 13 to be compressed and is discharged from the discharge port 11. The compressed air discharged from the discharge port 11 is supplied to the fuel cell stack 91 described above.

If a torque of the rotating shaft 15 is insufficient, the motor 21 applies a torque to the rotating shaft 15 to compensate for the deficiency. That is, when a current is supplied from the inverter main body 35 to a coil of the stator 29, a magnetic field is generated around the stator 29, and this magnetic field exerts a circumferential force on permanent magnets of the rotor 27, resulting in a torque being applied to the rotating shaft 15.

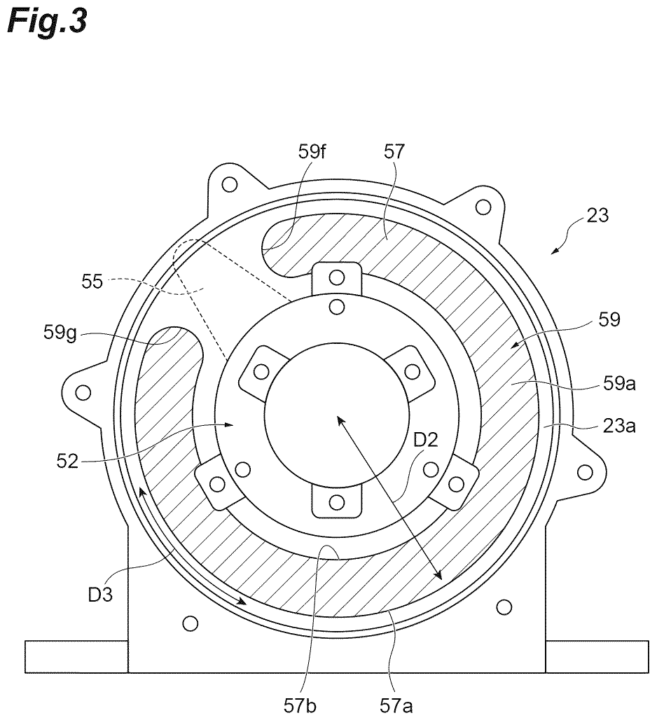

Next, a structure in the vicinity of a joint portion 50 between the compressor 3 and the motor unit 20 will be described. FIG. 2 is an enlarged cross-sectional view illustrating the vicinity of the joint portion 50. FIG. 3 is a view of a contact surface (e.g., joint surface 23a) of the motor case 23, which is joined to the compressor 3, from the axial direction D1. The compressor 3 includes a diffuser plate 51 in addition to the compressor housing 5 and the compressor impeller 7 described above. The diffuser plate 51 is positioned between the compressor housing 5 and the motor case 23. The diffuser plate 51 is joined to the turbine side of the compressor housing 5 and to the compressor side of the motor case 23. In a radially outer region of the compressor impeller 7, a diffuser 53, which is axially sandwiched between the diffuser plate 51 and the compressor housing 5, is formed. As a material for the diffuser plate 51, a metal with a low thermal conductivity such as, for example, stainless steel, is employed. A material of the diffuser plate 51 illustrated in FIG. 2 is stainless steel.

The radial bearing 43 and the thrust bearing 45, which are positioned around the rotating shaft 15, are attached to the motor case 23. A cooling air flow path 55 is formed in the motor case 23. The cooling air flow path 55 provides communication between the outside of the motor case 23 and a bearing housing space 52. The bearing housing space 52 is a space in which the radial bearing 43 and the thrust bearing 45 are housed. The cooling air flow path 55 allows cooling air sent from a cooling air source outside the motor unit 20 to flow to the radial bearing 43 and the thrust bearing 45. The radial bearing 43 and the thrust bearing 45 are cooled by the cooling air. The cooling air passes through the radial bearing 43 and the thrust bearing 45, then passes through the inside of the motor case 23, and is finally discharged from the exhaust gas outlet 10 together with the exhaust gas from the turbine 2. Further, as another structure for cooling the motor 21, a cooling water flow path 56 (see FIG. 1) is provided in the motor case 23. The cooling water flow path 56 is formed in a spiral shape within an outer wall portion of the motor case 23, and cools the motor 21 by causing cooling water supplied from an external cooling water source to flow therethrough.

At the joint portion 50 between the diffuser plate 51 and the motor case 23, a gap region 57, in which the diffuser plate 51 and the motor case 23 face each other in the axial direction D1 with an insulating gap (e.g., gap G) therebetween, is provided. The gap region 57 is located adjacent the contact surface 23a. For example, at the joint portion 50, the diffuser plate 51 and the motor case 23 are joined to each other with the joint surface 23a of the motor case 23 in contact with the joint surface 51a of the diffuser plate 51. Also, there is a recessed portion 59 in the joint surface 23a of the motor case 23. The recessed portion 59 is formed by a partial region of the joint surface 23a being slightly recessed toward the turbine side. A bottom surface 59a of the recessed portion 59 is a plane orthogonal to the axial direction D1 and faces the joint surface 51a of the diffuser plate 51 in the axial direction D1 with the gap G therebetween. A size of the gap G is, for example, about 1 mm. A region of the joint portion 50 in which the recessed portion 59 as described above is present corresponds to the gap region 57 described above. The recessed portion 59 is illustrated with hatching in FIG. 3.

When viewed from the axial direction D1, the gap region 57 extends in a belt-like shape in the circumferential direction D3 with a predetermined radial width along a circular arc centered on the rotation axis H. When viewed from the axial direction D1, the gap region 57 is located at a position that does not overlap the cooling air flow path 55. The recessed portion 59 that forms the gap region 57, includes a first recessed end 59f and a second recessed end 59g in the circumferential direction D3. The second recessed end 59g is located opposite the first recessed end 59f. When viewed in the axial direction D1, the cooling air flow path 55 is located between the first recessed end 59f and the second recessed end 59g, such that the cooling air flow path 55 does not overlap the recessed portion 59.

The gap region 57 is formed by an innermost circumferential surface (e.g., innermost circumferential portion 57b) of the recessed portion 59 in a radial direction D2 of the rotation axis (15) and an outermost circumferential surface (e.g., outermost circumferential portion 57b) of the recessed portion 59 that faces the innermost circumferential surface 57b in the radial direction D2. A radial position of the outermost circumferential portion 57a is outside a radial position 61 of an outlet 53a of the diffuser 53 (e.g. diffuser outlet). The outermost circumferential portion 57a may be located radially farther from the rotation axis 15 than the outlet 53a. Also, the radial position of the outermost circumferential portion 57a is positioned on an inner side in the radial direction D2 with respect to a radial position 62 of an outermost circumferential portion of the scroll 13 in the compressor 3. The innermost circumferential portion 57b may be located radially closer to the rotation axis 15 than the outlet 53a. The radial position of the outermost circumferential portion 57a may be the same as the radial position 61 of the outlet 53a of the diffuser 53 or may be the same as the radial position 62 of the outermost circumferential portion of the scroll 13 in the compressor 3.

Also, the radial position 61 of the outlet 53a of the diffuser 53 is positioned inward of the radial position of the outermost circumferential portion 57a of the gap region 57 and positioned outward of a radial position of an innermost circumferential portion 57b of the gap region 57.

Also, theoretically, there is a point (e.g., middle portion 53m) in the diffuser 53 at which a compressed air reaches its highest pressure. If a radial position of this point is denoted by reference sign 63 as illustrated in FIG. 2, a flow path width of the diffuser 53 in the axial direction D1 is constant on an inner side of the radial position 63, and the flow path width of the diffuser 53 in the axial direction D1 increases from the radial position 63 toward the outlet 53a of the diffuser 53 (radial position 61). The radial position 63 is positioned inward of the radial position of the outermost circumferential portion 57a of the gap region 57 and positioned outward of the radial position of the innermost circumferential portion 57b of the gap region 57. In the example illustrated in FIG. 2, the diffuser 53 includes the middle portion 53m, an inner portion 53b and an outer portion 53c. The inner portion 53b is located between the impeller 7 and the middle portion 53m, and has a constant flow path width. The outer portion 53c is located between the middle portion 53m and the scroll 12 and has a variable flow path width that increases from the middle portion 53m toward the scroll 12. The outermost circumferential portion 57a of the gap region 57 is located radially farther from the rotation axis 15 than the middle portion 53m. The innermost circumferential portion 57b of the gap region 57 is located radially closer to the rotation axis 15 than the middle portion 53m.

Also, an O-ring 67 sandwiched between the diffuser plate 51 and the motor case 23 is provided in the vicinity of the outermost circumference of the joint portion 50. The O-ring 67 prevents leakage of compressed air or the like to the outside through the joint portion 50. The outermost circumferential portion 57a of the gap region 57 is positioned on an inner side in the radial direction D2 relative to the position of the O-ring 67.

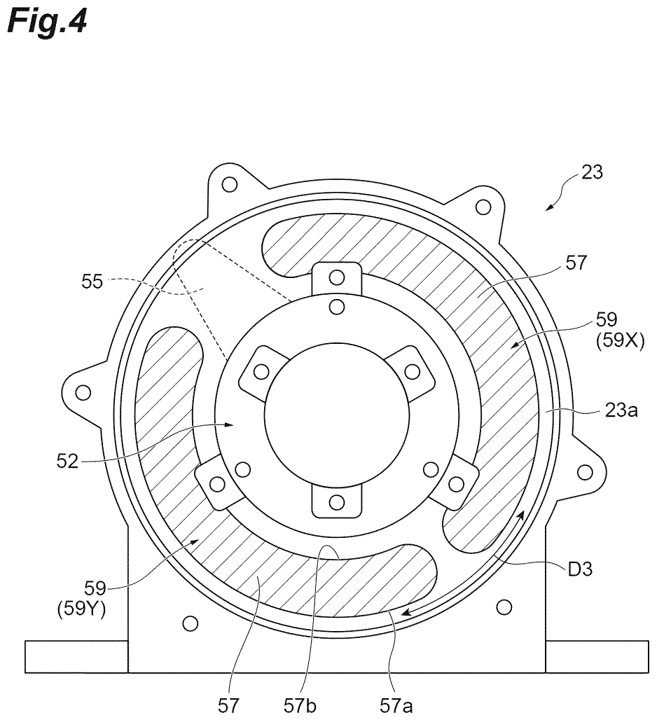

A projected area of the gap region 57 projected in the axial direction D1 is preferably 40% or more of a total projected area of the joint portion 50 projected in the axial direction D1. In this case, the total projected area of the joint portion 50 refers to a combined projected area of the projected area of the gap region 57 and the projected area of all portions in which the diffuser plate 51 and the motor case 23 are in contact with each other. Also, the projected area of the gap region 57 described above corresponds to an area of the hatched portion (recessed portion 59) in FIG. 3. Also, the gap region 57 may be divided into a plurality of regions in the circumferential direction D3 as illustrated in FIG. 4. In the example of FIG. 4, the gap region 57 is divided into two in the circumferential direction D3, but the gap region 57 may be divided into three or more. In the example of FIG. 4, the recessed portion 59 includes a first recessed portion 59X and a second recessed portion 59Y. The first recessed portion 59X forms a first insulating and the second recessed portion 59Y forms a second insulating gap. The first recessed portion 59X and the second recessed portion 59Y extend in the circumferential direction D2 around the rotation axis 15. The second recessed portion 59Y is spaced apart from the first recessed portion 59X.

An operation and effects of the electric turbocharger 1 described above will be described. In the electric turbocharger 1, the diffuser plate 51 of the compressor 3 and the motor case 23 of the motor unit 20 are joined in the axial direction D1 at the joint portion 50. In the compressor 3, heat is generated by adiabatic compression of air. If a large amount of the heat is conducted to the motor unit 20, it may cause an increase in temperature of the motor 21, and operating performance of the motor 21 may be reduced by the heat. Also, a load on the cooling system, including the cooling air flow path 55 and cooling water flow path 56, is increased.

In contrast, in the electric turbocharger 1, the gap region 57, in which the diffuser plate 51 and the motor case 23 face each other in the axial direction D1 with the gap G therebetween, is provided in the joint portion 50. Due to the presence of the gap G, heat transfer from the diffuser plate 51 to the motor case 23 is reduced, that is, transfer of heat from the compressor 3 to the motor unit 20 is suppressed. Therefore, a decrease in continuous operation performance of the motor 21 due to a temperature is suppressed. Also, the load on the cooling system for cooling the motor unit 20 can be reduced.

Also, when the projected area of the gap region 57 projected in the axial direction D1 is set to 40% or more of the total projected area of the joint portion 50 projected in the axial direction D1 as described above, the operation and effects described above can be efficiently achieved.

Also, when a metal with a low thermal conductivity such as, for example, stainless steel is employed as the material of the diffuser plate 51 as described above, transfer of heat from the compressor 3 to the motor unit 20 can be suppressed even in the portion in which the diffuser plate 51 and the motor case 23 are in contact.

Here, the pressure of the compressed air in the compressor 3 reaches its maximum at a point in the vicinity of the radial position 61 of the outlet 53a of the diffuser 53. Therefore, the temperature due to adiabatic compression of air is also considered to reach its maximum at the point in the vicinity of the radial position 61. In contrast, the radial position of the outermost circumferential portion 57a of the gap region 57 is positioned outward of the radial position 61 of the outlet 53a of the diffuser 53 and positioned inward of the radial position 62 of the outermost circumferential portion of the scroll 13. In this way, since the radial position 61 described above can become particularly high in temperature, the gap region 57 extends outward to a position beyond the point of the radial position 61. As a result, heat transfer from the diffuser plate 51 to the motor case 23 is further reduced more efficiently.

Also, the radial position 61 of the outlet 53a of the diffuser 53 is positioned inward of the radial position of the outermost circumferential portion 57a of the gap region 57 and positioned outward of the radial position of the innermost circumferential portion 57b of the gap region 57. In this way, the presence of the gap region 57, which radially spans across the above-described point of the radial position 61 that can become particularly high in temperature, allows heat transfer from the diffuser plate 51 to the motor case 23 to be further reduced more efficiently.

Also, the radial position 63 of the point at which the air compressed by the compressor 3 theoretically reaches the highest pressure is positioned inward of the radial position of the outermost circumferential portion 57a of the gap region 57 and positioned outward of the radial position of the innermost circumferential portion 57b of the gap region 57. In this way, the presence of the gap region 57, which radially spans across the above-described point of the radial position 63 that can theoretically become particularly high in temperature, allows heat transfer from the diffuser plate 51 to the motor case 23 to be further reduced more efficiently.

Also, if the cooling air flow path 55 and the recessed portion 59 are assumed to be provided in the motor case 23 to overlap each other in the axial direction D1, a portion between the cooling air flow path 55 and the bottom surface 59a of the recessed portion 59 would become thin. In contrast, in the electric turbocharger 1 illustrated in FIG. 3, since the gap region 57 is provided at a position that does not overlap the cooling air flow path 55 when viewed from the axial direction D1, it may ensure a sufficient thickness of the motor case 23 at the portion in which the cooling air flow path 55 is provided. Although there is no gap region 57 and the diffuser plate 51 is in contact with the motor case 23 in that region, most of the heat transferred from the diffuser plate 51 to the motor case 23 is removed by the cooling air passing through the cooling air flow path 55. In the example illustrated in FIG. 4, the recessed portion 59 includes a first recessed portion 59X and a second recessed portion 59Y. When viewed in the axial direction D1, the cooling air flow path 55 is located between the first recessed portion 59X and the second recessed portion 59Y, such that the cooling air flow path 55 does not overlap the recessed portion 59.

It is to be understood that not all aspects, advantages and features described herein may necessarily be achieved by, or included in, any one particular example. Indeed, having described and illustrated various examples herein, it should be apparent that other examples may be modified in arrangement and detail. For example, the gap region 57 is provided by forming the recessed portion 59 on the joint surface 23a of the motor case 23, but the gap region may be provided by forming a recessed portion on the joint surface 51a of the diffuser plate 51.

Some additional examples are disclosed as follows, with continued reference to the drawings for convenience of description.

An example electric turbocharger (1) includes a compressor (3), a motor (21) configured to apply torque to an impeller (7) of the compressor (3), a motor case (23) that houses the motor (21) and contacts the compressor (3) along a rotation axis (15) of the impeller (7), and a gap region (57) formed between the compressor (3) and the motor case (23) in an axial direction (D1) of the rotation axis (15) to suppress heat transfer from the compressor (3) to the motor (21).

In the example electric turbocharger (1), the motor case (23) may include a contact surface (23a) that contacts the compressor, and a recessed portion (59) located adjacent to the contact surface (23a). The gap region (57) may be formed by an innermost circumferential surface (57b) of the recessed portion (59) in a radial direction (D2) of the rotation axis (15), and an outermost circumferential surface (57a) of the recessed portion (59) that faces the innermost circumferential surface (57b) in the radial direction (D2). The compressor (3) may include a scroll (13), and a diffuser outlet (53a) fluidly coupled to the scroll (13). A radial position (62) of the outermost circumferential surface (57a) of the gap region (57) may be the same as, or located radially outward of, a radial position (61) of the diffuser outlet (53a).

In the example electric turbocharger (1), the radial position (62) of the outermost circumferential surface (57a) may be the same as, or located radially inward of, a radial position (62) of an outermost circumferential portion of the scroll (13).

In the example electric turbocharger (1), the motor case (23) may include a contact surface (23a) that contacts the compressor (3), and a recessed portion (59) located adjacent to the contact surface (23a). The gap region (57) may be formed by an innermost circumferential surface (57b) of the recessed portion (59) in a radial direction (D2) of the rotation axis (15), and an outermost circumferential surface (57a) of the recessed portion (59) that faces the innermost circumferential surface (57b) in the radial direction (D2). The compressor (3) may include a scroll (13), and a diffuser outlet (53a) fluidly coupled to the scroll (13). A radial position of the diffuser outlet (53a) may be located radially inward of a radial position of the outermost circumferential surface (57a) and radially outward of a radial position of the innermost circumferential surface (57b).

In the example electric turbocharger (1), the gap region (57) may be divided into a plurality of gaps (G) in a circumferential direction (D3) of the rotation axis (15).

In the example electric turbocharger (1), the motor case (23) may contact the compressor (3) along a contact surface (23a). The gap region (57) may be located adjacent the contact surface (23a). A cross-sectional area of the gap region (57) when viewed in the axial direction may be 40% or more of the contact surface (23a).

In the example electric turbocharger (1), the motor case (23) may include a bearing housing (52) that houses a bearing (43) supporting the rotation axis (15), a cooling air flow path (55) fluidly coupling the bearing housing to an outside of the motor case (23), wherein a cooling air for cooling the bearing (43) flows in the cooling air flow path (55). The gap region (57) may be located at a position that does not overlap a cooling air flow path (55) when viewed from the axial direction (D1).

In the example electric turbocharger (1), the compressor (3) may include a compressor housing (5), a diffuser plate (51) that contacts the motor case (23), and a diffuser (53) formed between the diffuser plate and the compressor housing (5).

In the example electric turbocharger (1), the diffuser plate (51) may be made of stainless steel.

Additionally, an example electric turbocharger (1) includes a compressor (3), a motor (21) configured to apply torque to an impeller (7) of the compressor (3), and a motor case (23) that houses the motor (21) and contacts the compressor (3) along a rotation axis (15) of the impeller (7). The motor case (23) includes a contact surface (23a) contacting the compressor (3) in an axial direction (D1) of the rotation axis (15), and a recessed portion (59) located adjacent the contact surface (23a) and forming a gap region (57) between the motor case (23) and the compressor (3) to suppress heat transfer from the compressor (3) to the motor (21).

In the example electric turbocharger (1), the compressor (3) may include a compressor housing (5) that houses the impeller (7), a diffuser plate (51) that contacts the contact surface of the motor case and a diffuser (53) formed between the diffuser plate and the compressor housing (5). The gap region (57) may be located between the recessed portion (59) and the diffuser plate (51).

In the example electric turbocharger (1), the recessed portion (59) may extend in a circumferential direction (D3) around the rotation axis (15).

In the example electric turbocharger (1), the motor case (23) may include a contact surface (23a) that contacts the compressor (3). The recessed portion (59) may be located adjacent the contact surface (23a). The recessed portion (59) may include an innermost circumferential surface (57b) of the motor case (23) in a radial direction (D2) of the rotation axis (15) and an outermost circumferential surface (57a) of the motor case (23) that faces the innermost circumferential surface (57b) in the radial direction (D2). The compressor (3) may include a scroll (13), and a diffuser outlet (53a) fluidly coupled to the scroll (13). The outermost circumferential surface (57a) is located radially farther from the rotation axis (15) than the diffuser outlet (53a).

In the example electric turbocharger (1), the innermost circumferential surface (57b) may be located radially closer to the rotation axis (15) than the diffuser outlet (53a).

In the example electric turbocharger (1), the motor case (23) may include a bearing housing (52) that houses a bearing (43) supporting the rotation axis (15), and a cooling air flow path (55) fluidly coupled to the bearing housing (52), through which a cooling air flows to cool the bearing (43), and, wherein a portion of the cooling air flow path is located adjacent to the contact surface (23a).

In the example electric turbocharger (1), the recessed portion (59) may extend in a circumferential direction (D3) around the rotation axis (15), and may comprise a first recessed end (59f) and a second recessed end (59g) located opposite the first recessed end (59f) in the circumferential direction (D3). In the circumferential direction (D3), the cooling air flow path (55) may be located between the first recessed end (59f) and the second recessed end (59g) such that, when viewed along the rotation axis (15), the cooling air flow path (55) does not overlap the recessed portion (59).

In the example electric turbocharger (1), the compressor (3) may include a scroll (13) and a diffuser (53) fluidly coupled with the impeller (7) and the scroll (13). The diffuser (53) may comprise a middle portion (53m), an inner portion (53b) located between the impeller (7) and the middle portion (53m), and having a constant flow path width and an outer portion (53c) located between the middle portion (53m) and the scroll (13) and having a variable flow path width that increases from the middle portion (53m) toward the scroll (13).

In the example electric turbocharger (1), the recessed portion (59) may include an innermost circumferential surface (57b) in a radial direction (D2) of the rotation axis (15) and an outermost circumferential surface (57a) that faces the innermost circumferential surface (57b) in the radial direction (D2). The innermost circumferential surface (57b) may be located radially closer to the rotation axis (15) than the middle portion (53m).

In the example electric turbocharger (1), the recessed portion (59) forms a first insulating gap (59X) extending in a circumferential direction (D3) around the rotation axis (15) and a second insulating gap (59X) extending in the circumferential direction (D3) and spaced apart from the first insulating gap (59X).

In the example electric turbocharger (1), the motor case (23) may include a bearing housing (52) that houses a bearing (43) supporting the rotation axis (15) and a cooling air flow path (55) fluidly coupled to the bearing housing (52), through which a cooling air flows to cool the bearing (43). The cooling air flow path (55) may be located between the first recessed portion (59X) and the second recessed portion (59Y) when viewed in the axial direction.

What is claimed is:

1. An electric turbocharger comprising:
a compressor;
a motor configured to apply torque to an impeller of the compressor;
a motor case that houses the motor and contacts the compressor along a rotation axis of the impeller; and
a gap region formed between the compressor and the motor case in an axial direction of the rotation axis to suppress heat transfer from the compressor to the motor.

2. The electric turbocharger according to claim 1,
wherein the motor case includes a contact surface that contacts the compressor, and a recessed portion located adjacent to the contact surface,
wherein the gap region is formed by:
an innermost circumferential surface of the recessed portion in a radial direction of the rotation axis; and
an outermost circumferential surface of the recessed portion that faces the innermost circumferential surface in the radial direction,
wherein the compressor includes:
a scroll; and
a diffuser outlet fluidly coupled to the scroll, and
wherein a radial position of the outermost circumferential surface of the gap region is the same as, or located radially outward of, a radial position of the diffuser outlet.

3. The electric turbocharger according to claim 2, wherein the radial position of the outermost circumferential surface is the same as, or located radially inward of, a radial position of an outermost circumferential portion of the scroll.

4. The electric turbocharger according to claim 1,
wherein the motor case includes a contact surface that contacts the compressor, and a recessed portion located adjacent to the contact surface,
wherein the gap region is formed by:
an innermost circumferential surface of the recessed portion in a radial direction of the rotation axis; and
an outermost circumferential surface of the recessed portion that faces the innermost circumferential surface in the radial direction,
wherein the compressor includes:
a scroll; and
a diffuser outlet fluidly coupled to the scroll; and,
wherein a radial position of the diffuser outlet is located radially inward of a radial position of the outermost circumferential surface and radially outward of a radial position of the innermost circumferential surface.

5. The electric turbocharger according to claim 1, wherein the gap region is divided into a plurality of gaps in a circumferential direction of the rotation axis.

6. The electric turbocharger according to claim 1,
wherein the motor case contacts the compressor along a contact surface,
wherein the gap region is located adjacent the contact surface, and
wherein a cross-sectional area of the gap region when viewed in the axial direction is 40% or more of the contact surface.

7. The electric turbocharger according to claim 1,
wherein the motor case includes:
a bearing housing that houses a bearing supporting the rotation axis;
a cooling air flow path fluidly coupling the bearing housing to an outside of the motor case, wherein a cooling air for cooling the bearing flows in the cooling air flow path, and
wherein the gap region is located at a position that does not overlap a cooling air flow path when viewed from the axial direction.

8. The electric turbocharger according to claim 1, wherein the compressor includes:
a compressor housing;
a diffuser plate that contacts the motor case; and
a diffuser formed between the diffuser plate and the compressor housing.

9. The electric turbocharger according to claim 8, wherein the diffuser plate is made of stainless steel.

10. An electric turbocharger comprising:
a compressor;
a motor configured to apply torque to an impeller of the compressor; and
a motor case that houses the motor and is joined to the compressor along a rotation axis of the impeller,
wherein the motor case comprises:
a contact surface contacting the compressor in an axial direction of the rotation axis, and
a recessed portion located adjacent the contact surface and forming a gap region between the motor case and the compressor to suppress heat transfer from the compressor to the motor.

11. The electric turbocharger according to claim 10,
wherein the compressor includes:
a compressor housing that houses the impeller;
a diffuser plate that contacts the contact surface of the motor case; and
a diffuser formed between the diffuser plate and the compressor housing, and
wherein the gap region is located between the recessed portion and the diffuser plate.

12. The electric turbocharger according to claim 10, wherein the recessed portion extends in a circumferential direction around the rotation axis.

13. The electric turbocharger according to claim 12,
wherein the motor case includes a contact surface that contacts the compressor,
wherein the recessed portion is located adjacent the contact surface and includes:
an innermost circumferential surface in a radial direction of the rotation axis; and
an outermost circumferential surface that faces the innermost circumferential surface in the radial direction,
wherein the compressor includes:
a scroll; and
a diffuser outlet fluidly coupled to the scroll, and
wherein the outermost circumferential surface is located radially farther from the rotation axis than the diffuser outlet.

14. The electric turbocharger according to claim 13, wherein the innermost circumferential surface is located radially closer to the rotation axis than the diffuser outlet.

15. The electric turbocharger according to claim 10, wherein the motor case includes:
a bearing housing that houses a bearing supporting the rotation axis; and
a cooling air flow path fluidly coupled to the bearing housing, through which a cooling air flows to cool the bearing, and, wherein a portion of the cooling air flow path is located adjacent to the contact surface.

16. The electric turbocharger according to claim 15,
wherein the recessed portion extends in a circumferential direction around the rotation axis, and comprises a first recessed end and a second recessed end located opposite the first recessed end in the circumferential direction, and
wherein, in the circumferential direction, the cooling air flow path is located between the first recessed end and the second recessed end such that, when viewed along the rotation axis, the cooling air flow path does not overlap the recessed portion.

17. The electric turbocharger according to claim 16,
wherein the compressor includes:
a scroll; and
a diffuser fluidly coupled with the impeller and the scroll, and
wherein the diffuser comprises:
a middle portion;
an inner portion located between the impeller and the middle portion, and having a constant flow path width; and
an outer portion located between the middle portion and the scroll and having a variable flow path width that increases from the middle portion toward the scroll.

18. The electric turbocharger according to claim 17,
wherein the recessed portion includes:
an innermost circumferential surface in a radial direction of the rotation axis; and
an outermost circumferential surface that faces the innermost circumferential surface in the radial direction, and
wherein the innermost circumferential surface is located radially closer to the rotation axis than the middle portion.

19. The electric turbocharger according to claim 10, wherein the recessed portion forms:
a first insulating gap extending in a circumferential direction around the rotation axis; and
a second insulating gap extending in the circumferential direction and spaced apart from the first insulating gap.

20. The electric turbocharger according to claim 19,
wherein the motor case includes:
a bearing housing that houses a bearing supporting the rotation axis; and
a cooling air flow path fluidly coupled to the bearing housing, through which a cooling air flows to cool the bearing, and
wherein the cooling air flow path is located between the first recessed portion and the second recessed portion when viewed in the axial direction.
